(19) United States
(12) Patent Application Publication
(10) Pub. No.: US 2021/0012243 A1
(43) Pub. Date: Jan. 14, 2021

(54) SYSTEM AND A METHOD FOR PROVIDING AND VISUALIZING INFORMATION OF A FABRIC PRODUCT

(71) Applicant: The Procter & Gamble Company, Cincinnati, OH (US)

(72) Inventors: Hongling CHEN, Beijing (CN); Haiyan SONG, Beijing (CN); Yi WEI, Beijing (CN); Lesheng ZHANG, Beijing (CN); Xiaozhen ZHANG, Beijing (CN); Lifeng ZHAO, Beijing (CN)

(21) Appl. No.: 16/925,475

(22) Filed: Jul. 10, 2020

(30) Foreign Application Priority Data
Jul. 12, 2019 (CN) 201910628990.6

(51) Int. Cl. G06N 20/00; G06T 7/00; G06N 3/02

(52) U.S. Cl. CPC G06N 20/00; G06T 7/0004; G06T 2207/20081; G06T 2207/30124; G06N 3/02

(57) ABSTRACT

The present disclosure relates to a system and method for providing textile information and visualizing the same. The method for determining a damage level of a textile includes: receiving an image of at least a part of the textile; receiving information about a fabric type of the at least a part of the textile; analyzing the image by using a machine learning method so as to identify a fabric attribute of the at least a part of the textile; determining a severity value associated with the identified fabric attribute by using the machine learning method according to the received image, the identified fabric attribute and the fabric type; and determining the damage level of the textile based on the determined severity value.

### TECHNICAL FIELD

The present disclosure relates to the field of computer image recognition, and in particular, to a system and method for providing textile information by using a machine learning method and for visualizing the same.

### BACKGROUND

Users around the world use various washing methods and products to clean and care for their textiles such as clothing. Currently, most washing machines can provide a plurality of washing modes to suit different types of clothing. Many washing products are available in the market at present for consumers to choose from. This poses certain difficulties for the consumers because it is difficult to determine the types of products from such a large variety of washing products and to apply the products for optimally cleaning and protecting their clothing. Further, this problem becomes more complicated due to the wide variety of weaves and materials of consumer clothing.

Conventionally, a consumer consults with a retail counter of a laundry or mall or supermarket. A counter consultant may identify the type and problem of the customer's clothing and provide a solution. The solution is then conveyed to the consumer for discussion. Finally, the consultant will recommend suitable care products and care methods for the user to choose.

However, this negotiation is very subjective. Even for the same piece of clothing, the type and quantity of identified defects and potential problems vary from consultant to consultant. Consultation results are more likely to vary with time, and the same consultant may provide different conclusions for the same consultation made at different times. The consultant may have difficulty in conveying to the client the defects identified thereby, and a trial-and-error process of testing the recommendations is time-consuming and tedious.

Therefore, an improved system and method are required for analyzing related information of a textile and recommending a care policy and product and for visualizing the same.

### SUMMARY

A novel system and method for analyzing related information of a textile and recommending a care policy and product and for visualizing the same are provided in the present disclosure.

According to a first aspect of the present disclosure, a method for determining a damage level of a textile is provided, comprising: receiving an image of at least a part of the textile; receiving information about a fabric type of the at least a part of the textile; analyzing the image by using a machine learning method so as to identify a fabric attribute of the at least a part of the textile; determining a severity value associated with the identified fabric attribute by using the machine learning method according to the received image, the identified fabric attribute and the fabric type; and determining the damage level of the textile based on the determined severity value.

The method according to the first aspect further comprises determining a risk type and level of the textile according to the fabric attribute and the fabric type; determining an estimated age of use of the textile according to the fabric attribute, the fabric type and the damage level; providing a recommended care policy according to the damage level of the textile and the risk type and level; providing a recommended care product according to the recommended care policy; generating simulated care results of caring the textile by using a plurality of care policies and care products; and providing an option for a user to purchase the care product.

According to a second aspect of the present disclosure, a method for determining a textile condition is provided, comprising: receiving a digital image of at least a part of the textile; electronically analyzing the received digital image by using a machine learning method so as to identify a fabric attribute of the at least a part of the textile, wherein the fabric attribute indicates the textile condition of the textile; and determining the textile condition of the textile in the analyzed digital image based on the identified fabric attribute.

According to a third aspect of the present disclosure, a method for providing a textile care recommendation is provided, comprising: receiving an image of at least a part of the textile; analyzing the image by using a machine learning method so as to identify a fabric attribute of the at least a part of the textile, wherein the fabric attribute indicates a textile condition of the textile; determining the textile condition of the textile in the analyzed digital image based on the fabric attribute; and recommending a textile care policy for caring the textile condition.

According to a fourth aspect of the present disclosure, a method for visualizing textile information is provided, comprising: displaying a first option so as to receive from a user an image of at least a part of the textile; displaying a second option so as to receive from the user information about a fabric type of the at least a part of the textile; analyzing the image by using a machine learning method so as to identify a fabric attribute of the at least a part of the textile; determining a damage level of the textile by using the machine learning method according to the received image, the fabric attribute and the fabric type; and displaying the damage level of the textile.

The method according to the fourth aspect further comprises: determining and displaying a risk type and level of the textile according to the fabric attribute and the fabric type; determining and displaying an age of use of the textile according to the fabric attribute, the fabric type, and the damage level; displaying a third option so as to receive a user input related to a personal preference; displaying a recommended care policy according to the damage level of the textile and the risk type and level; displaying a recommended care product according to the recommended care policy; displaying simulated care results of caring the textile by using a plurality of care policies and care products; and displaying a fourth option so as to enable the user to purchase the care product.

According to a fifth aspect of the present disclosure, an electronic device is provided, comprising: one or a plurality of processors; and a memory storing computer-executable instructions thereon, wherein when executed by the one or plurality of processors, the computer-executable instructions cause the one or plurality of processors to perform any aspect according to the aforementioned method.

According to a sixth aspect of the present disclosure, a non-transitory computer-readable medium storing computer-executable instructions thereon is provided, wherein when executed by one or a plurality of processors, the computer-executable instructions cause the one or plurality of processors to perform any aspect according to the aforementioned method.

Other features and advantages of the present invention will become clearer from the following detailed description of exemplary embodiments of the present invention with reference to the accompanying drawings.

### BRIEF DESCRIPTION OF THE DRAWINGS

The accompanying drawings that constitute a part of the specification describe embodiments of the present disclosure, and explain principles of the present disclosure together with the specification.

The present disclosure can be understood more clearly from the following Detailed Description with reference to the accompanying drawings, wherein:

FIG. 1 is a general architecture diagram of providing textile information according to an exemplary embodiment of the present invention;

FIG. 2 is a computing environment diagram of providing textile information according to an exemplary embodiment of the present invention;

FIG. 3A is a flowchart of determining a damage level of a textile according to an exemplary embodiment of the present invention;

FIG. 3B is a flowchart of providing other textile information according to an exemplary embodiment of the present invention;

FIG. 4 is a schematic diagram of a method for determining a damage level of a textile according to an exemplary embodiment of the present invention;

FIG. 5 is a schematic diagram of a convolutional neural network model according to an exemplary embodiment of the present invention;

FIG. 6A is a flowchart of a method for two-dimensionally visualizing textile information according to an exemplary embodiment of the present invention; FIG. 6B is a flowchart of a method for two-dimensionally visualizing textile information according to another exemplary embodiment of the present invention;

FIG. 7A to FIG. 7F are user interface diagrams of two-dimensional visualization of textile information according to an exemplary embodiment of the present invention;

FIG. 8 is a flowchart of determining a textile condition of a textile according to an exemplary embodiment of the present invention;

FIG. 9 is a flowchart of recommending a textile care policy according to an exemplary embodiment of the present invention; and

FIG. 10 is an exemplary configuration diagram of a computing device that can implement an embodiment according to the present invention.

### DETAILED DESCRIPTION

Preferred embodiments of the present invention will be described in detail below with reference to the accompanying drawings. Details and functions that are not necessary for the present invention are omitted to avoid confusion of the understanding of the present invention.

Please note that similar reference numerals and letters refer to similar items in the drawings, and therefore once an item is defined in a drawing, it does not need to be discussed in subsequent drawings.

In the present disclosure, terms “first,” “second,” etc. are only used for distinguishing between elements or steps, and are not intended to represent a chronological order, priorities, or importance.

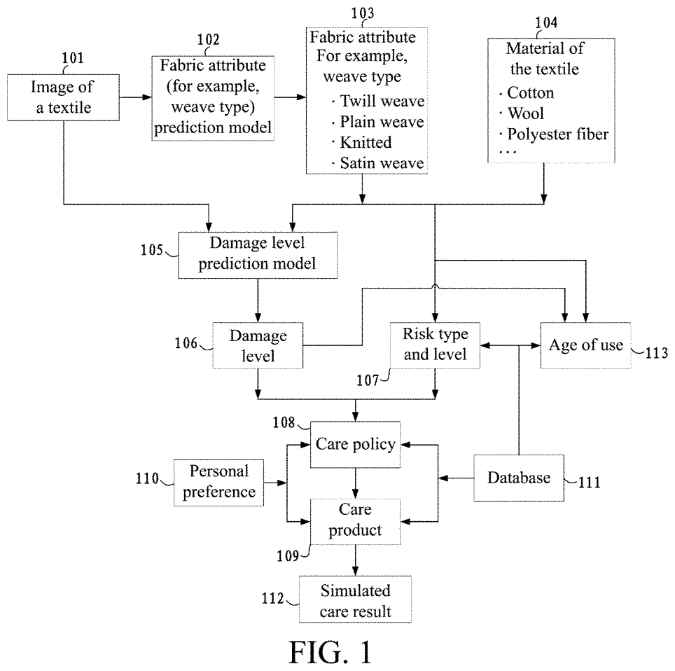

The general concept of the present invention is described below with reference to FIG. 1. FIG. 1 is a general architecture diagram for providing textile information according to an exemplary embodiment of the present invention. The textile herein may include original cloth and various final products made from the original cloth, such as clothing, clothing accessories, home textiles, decorative cloth products, gloves, and cloth toys. However, the scope of the present invention is not limited to this, but can be extended to products formed by any cloth and capable of being washed.

As shown in FIG. 1, a system receives from a user an image 101 of at least a part of a textile. The image 101 may be previously stored by the user or captured by the user in real time. The image 101 may be a macro image or another image capable of reflecting details of the textile. The user can capture the macro image of the textile by using a macro lens built in a portable device or an external macro lens connected to the portable device.

After receiving the image 101, the system analyzes the image 101 by using a pre-established fabric attribute prediction model 102 so as to obtain a fabric attribute 103 of the textile. The fabric attribute may be weave type, gloss, elasticity, or a combination thereof. For ease of description, the following description is made by taking the weave type as an example of the fabric attribute, but those skilled in the art will understand that the concept of the present invention can also be applied to the analysis of another fabric attribute or a combination of a plurality of fabric types. The weave type is related to the structure of the textile, and a specific pattern of the weave type can indicate a textile condition and/or damage level of the textile.

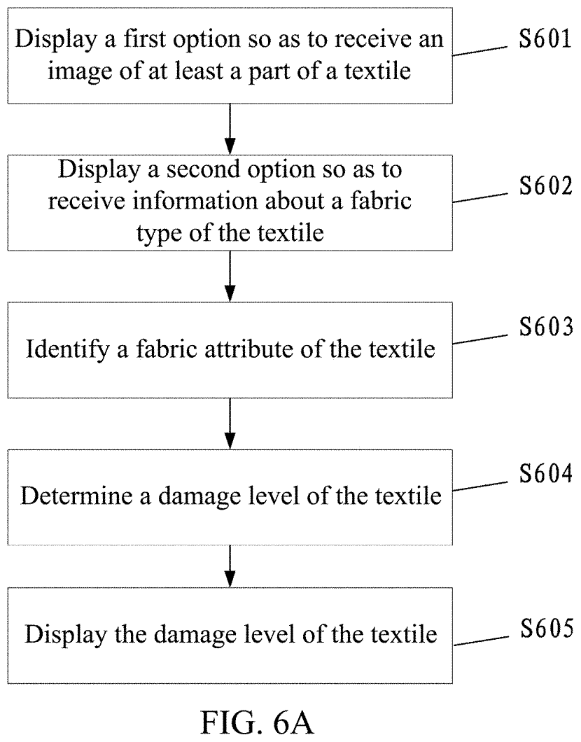

The weave type 103 may include, for example, four types: twill weave, plain weave, knitted, and satin weave. The weave type prediction model 102 can be obtained by training a convolutional neural network (CNN) by using a training sample set including a large quantity of textile images. A CNN model will be further described below with reference to FIG. 5.

The system also receives from the user an input 104 related to a fabric type, i.e., a material type or a cloth type, of the textile. The material type may include one or more of cotton, TENCEL™, recycled fiber, polyester fiber, lyocell, nylon, high content polyester, low content polyester, modal, wool, cashmere, rayon, acrylic fiber, viscose fiber, artificial cotton, and silk fabric. The silk fabric may include one or more of natural silk fabric, rayon fabric, and silk.

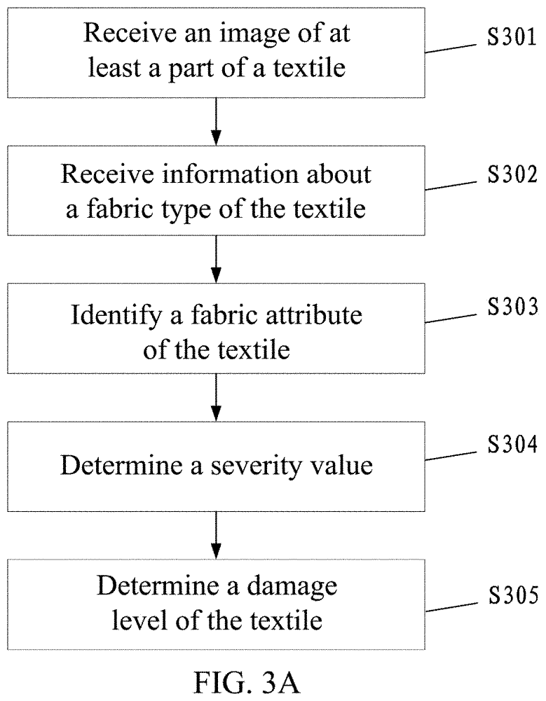

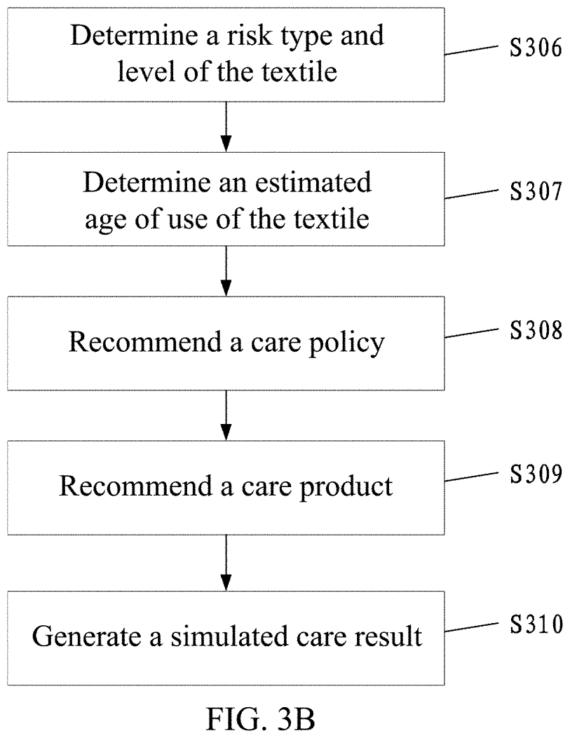

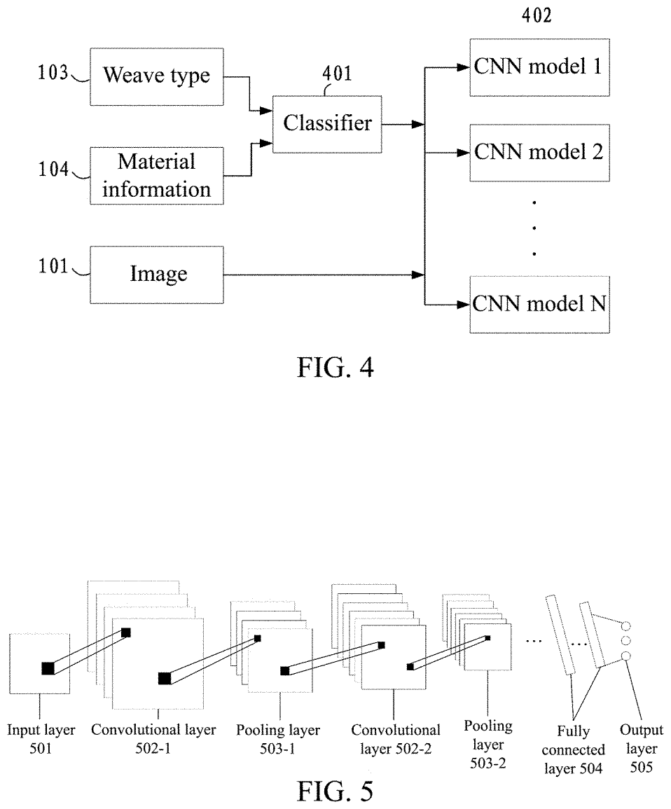

The system uses a damage level prediction model 105 to analyze the image 101 according to the weave type 103 and the material type 104 so as to obtain a damage level 106 of the textile. The damage level 106 may be displayed as a statistical graphic, text, word cloud graphic superimposed on the textile image, or any combination thereof. The damage level prediction model 105 may include a plurality of convolutional neural network models, and each convolutional neural network model corresponds to a combination of at least one weave type in a plurality of weave types and at least one material type in a plurality of material types. This step will be further described below with reference to FIG. 3A and FIG. 4.

Optionally or further, the system may also determine a risk type and level 107 of the textile according to the weave type 103 and the material type 104. The risk type and level 107 can be determined by searching a database 111 that stores weave types, material types, and corresponding risk types and levels. The risk type may include one or more of fluffing, pilling, deformation, discoloration, wrinkles, shrinkage, odor, and static electricity. The risk level may also be displayed as a statistical graphic, text, word cloud graphic superimposed on the textile image, or any combination thereof.

Optionally or further, the system may also infer an age of use 113 of the textile according to the weave type 103, the material type 104, and the damage level 106. The age of use 113 can be determined by searching the database 111 that stores weave types, material types, damage levels, and corresponding ages of use.

Optionally or further, the system may recommend a care policy 108 according to the damage level 106 and the risk type and level 107. The care policy 108 can be determined by searching the database 111 that stores damage levels, risk types and levels, and corresponding care policies. The care policy may include, for example, the water temperature, the washing mode and the like that should be used for caring clothing.

Optionally or further, the system may recommend a care product 109 according to the care policy 108. The care product 109 can be determined by searching the database 111 that stores care policies and corresponding care products. The care product may include the brand and the kind of detergent and/or softener, etc.

In addition, the care policy 108 and care product 109 may also be recommended with reference to a personal preference 110 inputted by the user. For example, the kind of detergent that the user is more used to use, etc.

Optionally or further, the system may generate simulated care results 112 of washing the textile by using different care policies and products. For example, the system may generate the simulated care result 112 for one or more of a default care policy and care product, a user-selected care policy and care product, and the recommended care policy and recommended care product.

It should be appreciated that FIG. 1 is illustrative and is not intended to limit the embodiment of the present disclosure. Those of ordinary skill in the art will recognize other variations, modifications, and alternatives.

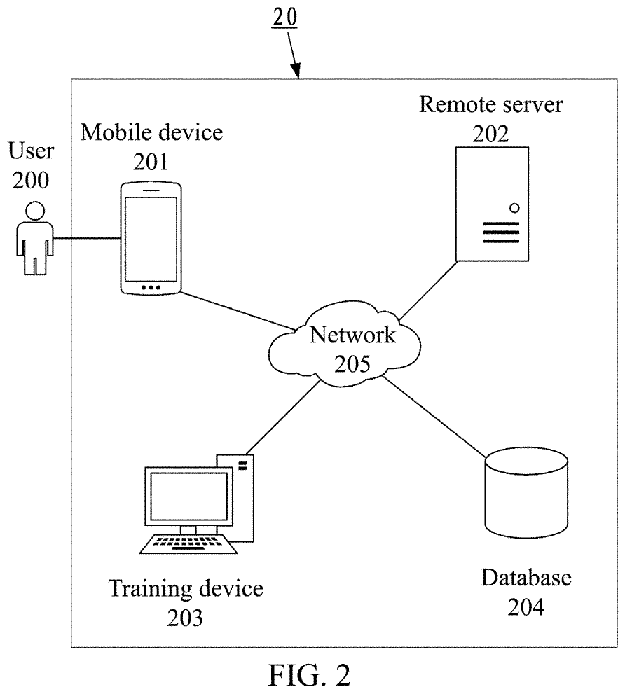

FIG. 2 is a computing environment diagram of a system 20 for providing textile information according to an exemplary embodiment of the present invention. The system 20 may include a mobile device 201, a remote server 202, a training device 203, and a database 204, which are coupled to each other via a network 205. The network 205 may be embodied as a wide area network (such as a mobile phone network, a public switched telephone network, a satellite network, and the Internet), a local area network (such as Wi-Fi, Wi-Max, ZigBee™, and Bluetooth™) and/or other forms of networking functions.

The mobile device 201 may be a mobile phone, a tablet computer, a laptop computer, a personal digital assistant and/or another computing apparatus configured to capture, store and/or transmit an image such as a digital photo. Therefore, the mobile device 201 may include an image capturing apparatus such as a digital camera and/or may be configured to receive an image from another apparatus. The mobile device 201 may include a display. The display may be configured to provide a user 200 with one or a plurality of user interfaces. The user interface may include a plurality of interface elements. The user 200 may interact with the interface elements, and the like. For example, the user 200 may use the mobile device 201 to photograph the textile, upload or store an image, and input material information related to the textile. The mobile device 201 may output to the user status information related to the textile and recommend a care policy and product, and the like.

The remote server 202 may be configured to analyze the textile image and the material information received from the mobile device 201 via the network 205 so as to determine a damage level of the textile, a risk type and level, and recommend a care policy and care product. The remote server 202 may also be configured to create and train a convolutional neural network (CNN).

The training device 203 may be coupled to the network 205 so as to facilitate the CNN training. The training device 203 may have a plurality of CPUs and/or GPUs to assist in the CNN training. For example, a trainer may provide one or a plurality of digital images of the textile to the CNN via the training device 203. The trainer may also provide information and other instructions to inform the CNN of correct and incorrect evaluations. The CNN can automatically adjust its own parameters based on the input from the trainer.

The database 204 may be coupled to the network 205 and provide data required by the remote server 202 for related computing. For example, the database 204 may store data related to fabric attributes, material types, damage levels, risk types and levels, care policies and care products, and so on. The database can be implemented by using various database technologies known in the art. The remote server 202 may access the database 204 as needed so as to perform related computing.

It should be understood that the computing environment herein is merely an example. Those skilled in the art may add more apparatuses or delete some apparatuses as needed, and may modify functions and configurations of some apparatuses.

A method for providing textile information according to an exemplary embodiment of the present invention is described below with reference to FIG. 3A and FIG. 3B.

Referring to FIG. 3A, in step S301, a system receives an image of at least a part of a textile. As mentioned above, the image may be previously stored by a user or captured by the user in real time. The user can photograph a main part or a damaged part of the textile. The image may be a macro image or another image that can reflect details of the textile. The user can capture the macro image of the textile by using a macro lens built in a portable device or an external macro lens connected to the portable device.

In step S302, the system receives information about a fabric type, i.e., a material type, of the textile. The user can input the material type of the textile by manually inputting the material type or by checking an option of the material type provided on the mobile device. As mentioned above, the material type may include one or more of cotton, TENCEL™, recycled fiber, polyester fiber, lyocell, nylon, high content polyester, low content polyester, modal, wool, cashmere, rayon, acrylic fiber, viscose fiber, artificial cotton, and silk fabric. It should be understood that the material types are not limited to 15 types, but may include other material types that are currently known or will be developed in the future. When the textile is formed by a plurality of material types, the user may input a plurality of materials at the same time, or select a main material for input. For example, if cotton accounts for 80% and modal accounts for 20% in the composition of a piece of clothing, then the user may input cotton as the material type of the clothing, or input cotton and modal as the material types.

In step S303, the system analyzes the textile image by using a machine learning method so as to identify a fabric attribute of the textile.

The machine learning method may include a deep learning method. As known to those skilled in the art, various deep learning models for the computer vision recognition technology have been proposed at present. For example, convolutional neural network (CNN), regional convolutional neural network (R-CNN), fast regional convolutional neural network (fast R-CNN), You Only Look Once (YOLO), Single Shot MultiBox Detector (SSD), etc. are proposed. The present invention is described by using the CNN as an example. It should be understood that the concept of the present invention can be practiced by using other deep learning models that are currently known or will be developed in the future.

In this step, the image is analyzed by using a pre-established fabric attribute prediction model so as to obtain the fabric attribute of the textile. For example, if the fabric attribute is a weave type, then the weave type may include, for example, four types: twill weave, plain weave, knitted, and satin weave. It should be understood that the weave types are not limited to four types, but may include other weave types that are currently known or will be developed in the future. The fabric attribute prediction model can be obtained by training the CNN by using a training sample set including a large quantity (for example, thousands) of textile images.

In step S304, the system determines a severity value of the textile by using the machine learning method according to the textile image, the identified fabric attribute and the information about the material type.

This step is described in more detail below with reference to FIG. 4. As shown in FIG. 4, the damage level of the textile may be determined by using a severity prediction model 402. The severity prediction model 402 may include a plurality of CNN models, namely, a CNN model 1, a CNN model 2, . . . , and a CNN model N. In an embodiment where the fabric attribute is the weave type, each CNN model corresponds to a combination of at least one weave type in the plurality of weave types and at least one material type in the plurality of material types. For example, for 4 weave types and 15 material types, if both the weave type and the material type of the textile are selected as a single type, then a total of 60 combinations may exist, such as cotton+twill weave, cotton+plain weave, polyester fiber+twill weave, . . . , etc. Therefore, 60 CNN models may exist.

Further, a CNN model can be constructed for a textile composed of a composite material formed by a plurality of material types and a plurality of weave types. For example, a CNN model for cotton+modal+plain weave can be created. In addition, in order to reduce the computing difficulty, CNN models for relatively rare combinations, such as a combination of cotton+satin weave, can be omitted. Therefore, the quantity of the CNN models is not limited to 60, but may be greater or less. Each CNN model is trained by using images of a plurality of textiles formed by corresponding weave types and corresponding material types and having different severity values.

In practice, each CNN model can be trained by using textile images captured after a plurality of rounds of machine-washing of the textile. The damage level of the textile will vary according to the number of times that the textile is machine-washed. Therefore, images of corresponding damage levels may be obtained by machine-washing the textile a plurality of times.

The system inputs to a classifier 401 the identified weave type and the information about the material type. The classifier 401 determines, according to the received weave type and material type, a CNN model in the plurality of CNN models 402 that should be used for prediction. The corresponding CNN model is activated to receive the image 101 of the textile and analyze the image 101 to determine a severity value. The severity value may be, for example, 0 to N, where N is any integer greater than 0.

In step S305, the system determines the damage level of the textile according to the severity value. For example, a severity value of 0 may correspond to no damage, 1 may correspond to mild damage, 2 may correspond to moderate damage, and 3 may correspond to severe damage. It should be noted that the severity values 0-3 and the damage levels are examples only, and those skilled in the art can expect the severity values and damage levels of any granularity.

In addition to determining the damage level of the textile, optionally or further, the system may also determine other information of the textile. The description is made below with reference to FIG. 3B.

Referring to FIG. 3B, in step S306, the system may also determine a risk type and level of the textile according to the weave type and the material type. As mentioned above, the risk type and level can be determined by searching the database that stores weave types, material types, and corresponding risk types and levels. The risk type may include one or more of fluffing, pilling, deformation, discoloration, wrinkles, shrinkage, odor, and static electricity.

In step S307, the system may also infer an estimated age of use of the textile according to the weave type, the material type, and the damage level. The age of use can be determined by searching the database that stores weave types, material types, damage levels, and corresponding ages. For example, the database may store data of “cotton+plain weave+moderate damage: the estimated age of use is 2 years.” The system can obtain the estimated age of use of the textile by looking up corresponding entries in the database. It should be understood that the form of data in the database is not limited to the exemplary form described herein, but may adopt various storage manners commonly used in databases, such as identifier mapping.

In step S308, the system may recommend a care policy according to the damage level and the risk type and level. The care policy may include, for example, the water temperature, the washing mode and the like that should be used for caring clothing. The care policy can be determined by searching the database that stores damage levels, risk types and levels, and corresponding care policies. For example, the database may store data of “silk+plain weave+mild damage: The care policy is to wash with cold water to better protect the color of the fabric. Select a laundry bag during machine-washing, and select a quick wash mode to preserve the shape of the fabric after repeated washing. Use the softener to make the clothing have a better wearing experience, elegant and stylish without sticking to the body.” The system can obtain the recommended care policy for the textile by looking up corresponding entries in the database. It should be noted that this care policy is only an example. Those skilled in the art can provide a more specific or simpler care policy recommendation or use different expressions according to the concept of the present invention.

In step S309, the system may recommend a care product according to the care policy. The care product may include the brand and the kind of detergent and/or softener, etc. The care product can be determined by searching the database that stores care policies and corresponding care products. For example, the database can store data of “cold water washing+quick washing mode: the care product is Tide® natural clothing-protection laundry detergent (with natural rejuvenation essence added to achieve pilling removal and smoothen the clothing).” The system can obtain the recommended care product for the textile by looking up corresponding entries in the database. It should be noted that this care product is only an example. Those skilled in the art can provide other suitable care products according to the concept of the present invention.

In addition, the care policy and care product may also be recommended with reference to a personal preference inputted by the user. For example, the kind of detergent that the user is more used to use, etc.

In step S310, the system may generate simulated care results of the textile obtained after washing the textile by using different care policies and products. For example, the system may generate the simulated care result for one or more of a default care policy and care product, a user-selected care policy and care product, and the recommended care policy and recommended care product.

It should be noted that some of the steps in FIG. 3A and FIG. 3B are not necessarily performed in the illustrated order, but can be performed simultaneously, in a different order, or in an overlapping manner. In addition, those skilled in the art may add some steps or omit some steps as needed.

FIG. 5 is a schematic diagram of a convolutional neural network model according to an exemplary embodiment of the present invention.

As known to those skilled in the art, a convolutional neural network (CNN) is a feed-forward type artificial neural network, and generally includes an input layer 501, a plurality of convolutional layers 502-1, 502-2 . . . (collectively referred to as 502 hereinafter), a plurality of pooling layers 503-1, 503-2 . . . (collectively referred to as 503 hereinafter), a plurality of fully connected layers 504, and an output layer 505. The input layer 501 receives an input image. The convolutional layer 502 implements the inner product operation of pixels of the input image and convolution kernels. The quantity and size of the convolution kernels may be set according to specific applications. The pooling layer 503 can reduce the size of a feature map generated by the convolutional layer.

Common pooling methods include maximum pooling, average pooling, and the like. The fully connected layer 504 can integrate features in the image feature map passing through the plurality of convolutional layers and pooling layers, so as to be used for image classification subsequently. The output layer 505 outputs a result of the image classification. For example, if the damage level is specified as 0 to 3, then the output layer outputs one of 0 to 3.

Under the teaching of the concept of the present invention, those skilled in the art can train the CNN model by using the training sample set containing a large quantity of textile images so as to obtain a trained CNN model with specific parameters for the system according to the embodiment of the present invention to use.

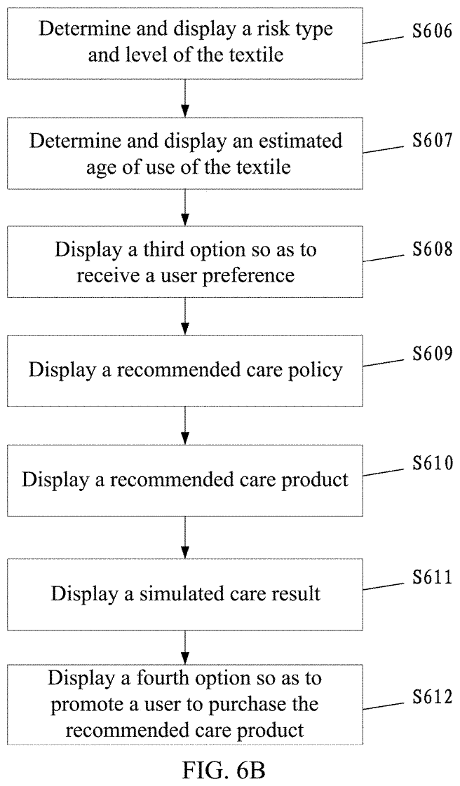

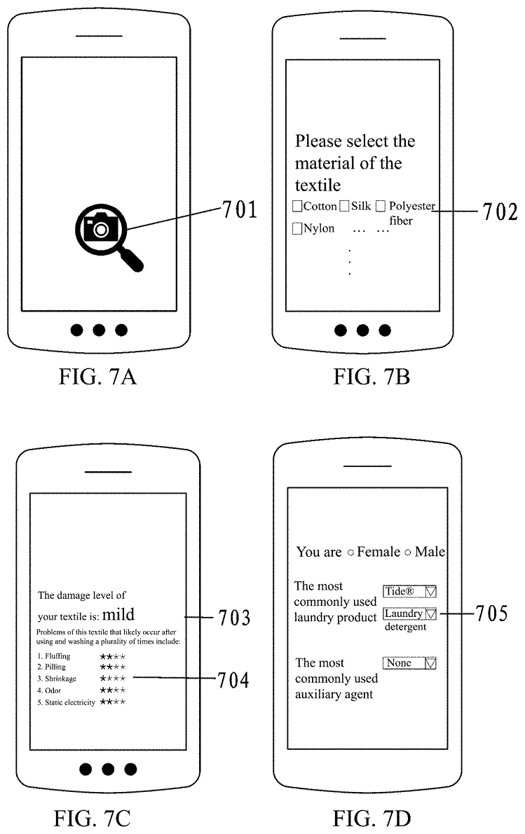

Another aspect of the present invention relates to visualizing textile information. For example, the method of the present invention may be implemented as an executable program on a personal computer or the like, an application on a mobile smart device, and/or an applet running in another application on the mobile smart device. The following description is made with reference to method flowcharts of FIG. 6A and FIG. 6B and user interface (UI) diagrams of FIG. 7A to FIG. 7F. This embodiment mainly focuses on how to visualize information about the textile. For those features that are the same as or similar to the corresponding features in the foregoing, the various aspects described in the foregoing will also be applicable to the method and system of this embodiment, and therefore a detailed description thereof will be omitted. Although the method of visualization in a two-dimensional format is described with reference to the method flowcharts of FIG. 6A and FIG. 6B and the user interface (UI) diagrams of FIG. 7A to FIG. 7F, those skilled in the art should understand that the present invention may include visualization in a three-dimensional format.

Referring to FIG. 6A, in step S601, a system displays a first option so as to receive from a user an image of at least a part of a textile. As shown in FIG. 7A, an icon 701 is displayed on a display screen of a mobile device, and the user may click on the icon to photograph the textile or select a previously captured picture from an album.

In step S602, the system displays a second option so as to receive from the user information about a fabric type, i.e., a material type, of the textile. As shown in FIG. 7B, an interface element 702 on the display screen prompts the user to input material information of the textile, and provides a plurality of material types for the user to select. The user may input the material type by checking a corresponding check box. It should be understood that this is only an example of inputting the material type. Those skilled in the art may also adopt another manner of inputting the material type. For example, the system may display a text box for the user to manually input the material type.

In step S603, the system analyzes the image by using a pre-constructed textile fabric attribute prediction model so as to identify a fabric attribute of the textile. This step can be performed by using the method described with reference to FIG. 3A and FIG. 5. The identified fabric attribute may not necessarily be displayed on the display screen, or may be displayed on the display screen for the user to confirm.

In step S604, the system determines a damage level of the textile by using a machine learning method according to the image, the fabric attribute, and the information about the fabric type. This step can be performed by using the method described with reference to FIG. 3A and FIG. 4.

In step S605, the system displays the damage level of the textile. As shown in FIG. 7C, an interface element 703 is displayed on the display screen of the mobile device, and indicates that the damage level of the textile is mild. It should be understood by those skilled in the art that the manner of displaying the damage level is not limited to text, but may adopt a statistical graphic (such as a bar graph), text (such as undamaged, mild, moderate, and severe), numerical percentage, word cloud graphic superimposed on the textile image, or any combination thereof.

In addition to displaying the damage level of the textile, optionally or further, the system may also display other information about the textile. The description is made below with reference to FIG. 6B.

In step S606, the system determines and displays a risk type and level of the textile according to the fabric attribute and the information about the material type. As shown in FIG. 7C, an interface element 704 is displayed on the display screen of the mobile device, and indicates the risk type and level of the textile. In this example, the risks shown include fluffing, pilling, shrinkage, odor, and static electricity. The corresponding risk levels are two stars, two stars, one star, two stars, and two stars. Those skilled in the art should understand that the manner of displaying the risk type and level is not limited to the manner shown in FIG. 7C, but can adopt a statistical graphic, text, numerical percentage, word cloud graphic superimposed on the textile image, or any combination thereof.

In step S607, the system determines and displays an estimated age of use of the textile according to the fabric attribute, the information about the material type, and the damage level. The estimated age of use may not necessarily be displayed on the display screen, or may be displayed on the display screen for the user to confirm.

In step S608, the system displays a third option so as to receive a user input related to a personal preference. As shown in FIG. 7D, an interface element 705 is displayed on the display screen of the mobile device, and indicates various personal preferences for the user input. In this example, the system may display options related to the user's gender, the most frequently used laundry product, and the most commonly used auxiliary agent for the user to select. Those skilled in the art should understand that the system may provide other options related to the personal preferences for the user to input. The system may also provide an option to enable the user to manually input related information.

In step S609, the system displays a recommended care policy according to the damage level of the textile and the risk type and level. Optionally or further, the system may also display the recommended care policy according to the personal preference inputted by the user. As shown in FIG. 7E, a recommended care policy “Wash with cold water to better protect the color of the fabric. Select a laundry bag during machine-washing, and select a quick wash mode to preserve the shape of the fabric after repeated washing. Use the softener to make the clothing have a better wearing experience, elegant and stylish without sticking to the body” is displayed on the display screen. It should be noted that the manners of expressing and displaying the care policy are examples only. Those skilled in the art can provide more specific or simpler care policy recommendations or use different displaying manners according to the concept of the present invention.

In step S610, the system displays a recommended care product according to the recommended care policy. As shown in FIG. 7F, an interface element 707 is displayed on the display screen, and indicates the recommended care product. In this example, the care product is Tide® natural clothing-protection laundry detergent (with natural rejuvenation essence added to achieve pilling removal and smoothen the clothing). The system may also display a product image of the recommended product to facilitate the user in identification and purchasing. It should be noted that the manner of displaying the care product is an example only. Those skilled in the art can use different displaying manners according to the concept of the present invention.

In step S611, the system displays simulated care results of caring the textile by using a plurality of care policies and care products. The plurality of care policies and care products include one or more of a default care policy and care product, a user-selected care policy and care product, and the recommended care policy and recommended care product. As shown in FIG. 7F, an interface element 708 is displayed on the display screen, and indicates the simulated care results. In this example, the system displays simulated care results of caring the textile in the case of adopting a common washing method and a common detergent (for example, the detergent selected by the user when inputting the personal preference) and in the case of adopting the system recommended care policy and product. The simulated care results take the form of radiation patterns. Each radiation bar represents a possible risk, and a bar located farther away from the center indicates a higher corresponding risk. The dotted line and the thickened solid line indicate the simulation results of common washing and recommended washing, respectively. It can be seen that the common washing method will lead to a higher risk of pilling, fluffing, static electricity, odor, shrinkage, and wrinkles for the textile. It should be noted that the manner of displaying the simulated care results shown in FIG. 7F is an example only. Those skilled in the art can use different displaying manners according to the concept of the present invention, as long as different washing results can be distinguished from each other. For example, the results of common washing and recommended washing may be represented using different colors in place of different lines. The results of the two kinds of washing may also be represented by using different shaded areas.

In step S612, the system displays a fourth option so as to enable the user to purchase the care product. As shown in FIG. 7F, an interface element 709 is displayed on the display screen, and guides the user to purchase the recommended care product.

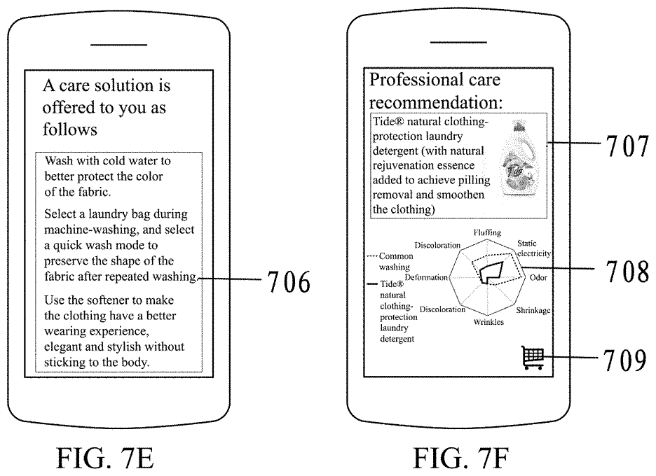

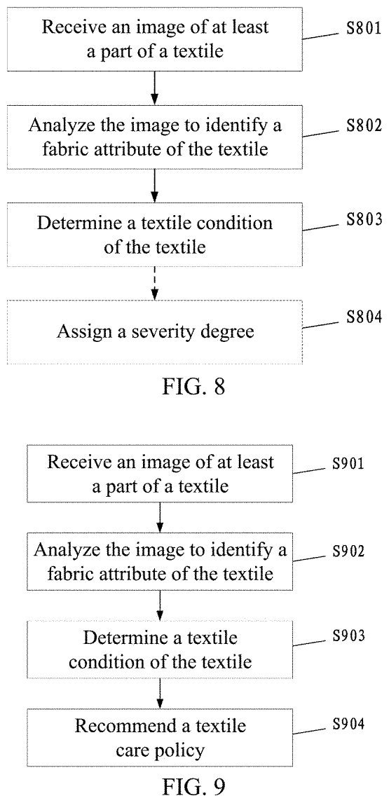

In addition to analyzing the condition of the used textile, the present invention can also be used to analyze the condition of a new textile that has not been used, and provide the user with a corresponding care recommendation. The description is made below with reference to FIG. 8 and FIG. 9.

FIG. 8 describes a flowchart of determining a textile condition of a textile according to another exemplary embodiment of the present invention. The textile of this embodiment may be a textile that has been used or a new textile that has not been used. For those features that are the same as or similar to the corresponding features in the foregoing, the various aspects described in the foregoing will also be applicable to the method and system of this embodiment, and therefore a detailed description thereof will be omitted.

In step S801, a system receives a digital image of at least a part of the textile.

In step S802, the system electronically analyzes the received digital image by using a machine learning method in combination with a pre-established fabric attribute database so as to identify a fabric attribute of the at least a part of the textile, where the fabric attribute can indicate a textile condition of the textile. The fabric attribute may be weave pattern, fabric type, gloss, elasticity, or a combination thereof. This step can be performed by using the method previously described with reference to FIG. 3A, FIG. 4, and FIG. 5. For example, the magnitude of glossiness of the textile and the like can be identified.

In step S803, the system determines the textile condition of the textile in the analyzed digital image based on the identified fabric attribute. For example, the system can determine, based on the magnitude of glossiness, the textile condition such as whether the textile is new or has a mild damage. This step can be completed by using a deep learning model, or by performing comparison against images stored in a database so as to obtain the corresponding textile condition. The embodiment of determining the textile condition according to the deep learning model has been described in the foregoing and will not be repeated herein. When the corresponding textile condition is acquired by performing comparison against the images stored in the database, one implementation may be that a plurality of images of a plurality of textiles that are formed by specific fabric attributes (e.g., weave pattern) and specific material types and have different stages are stored in the database in advance, where each stage represents a different damage degree of the specific fabric attribute (e.g., weave pattern) and specific material type. By comparing the image of the textile with the images in the database, the textile condition of the textile can be obtained.

Optionally or additionally, the method further includes step S804, in which the system assigns a severity degree to the textile condition of the textile in the analyzed digital image. For example, the severity degree can be determined by comparing the textile condition with predetermined values associated with a group of images of the fabric attribute. The severity degree of the textile condition may be a fabric damage value.

FIG. 9 is a flowchart of recommending a textile care policy according to another exemplary embodiment of the present invention. The textile of this embodiment may be a textile that has been used or a new textile that has not been used. For those features that are the same as or similar to the corresponding features in the foregoing, the various aspects described in the foregoing will also be applicable to the method and system of this embodiment, and therefore a detailed description thereof will be omitted.

In step S901, a system receives a digital image of at least a part of the textile.

In step S902, the system analyzes the received digital image by using a machine learning method in combination with a pre-established fabric performance database to identify a fabric attribute of the at least a part of the textile, where the fabric attribute can indicate a textile condition of the textile. The fabric attribute may be weave pattern, fabric type, gloss, elasticity, or a combination thereof. This step can be performed by using the method previously described with reference to FIG. 3A, FIG. 4, and FIG. 5. For example, the magnitude of glossiness of the textile and the like can be identified.

In step S903, the system determines the textile condition of the textile in the analyzed digital image based on the identified fabric attribute. For example, the system can determine, based on the magnitude of glossiness, the textile condition such as whether the textile is new or has a mild damage. This step can be completed by using a deep learning model, or by performing comparison against images stored in a database so as to obtain the corresponding textile condition.

In step S904, the system recommends a textile care policy for caring the textile condition. This step can be performed by using the method previously described with reference to FIG. 1, FIG. 3B, FIG. 4, and FIG. 5.

Optionally or additionally, although not shown, the method may also include the step of assigning a severity degree as described with reference to FIG. 8. In this step, the system assigns the severity degree to the textile condition of the textile in the analyzed digital image. For example, the severity degree can be determined by comparing the textile condition with predetermined values associated with a group of images of the fabric attribute. The severity degree of the textile condition may be a fabric damage value.

The system and method of the present invention use deep learning techniques to analyze the textile condition and provide corresponding care recommendations, thus improving the accuracy and objectivity of analysis. In addition, the present invention can present to the user various kinds of information about the textile more intuitively, thus improving user experience. In addition, by providing the user with a professional care recommendation conveniently, the product sales effectiveness can be improved and marketing costs can be reduced.

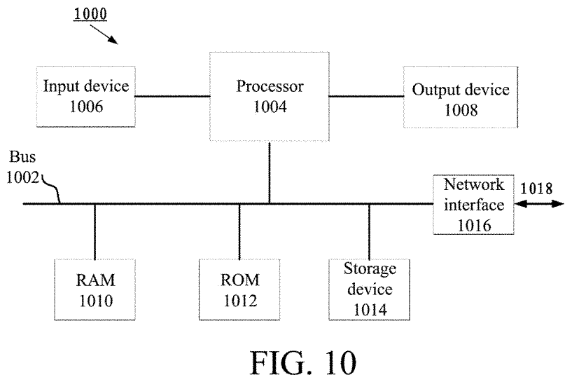

FIG. 10 shows exemplary configurations of a computing device 1000 that can implement an embodiment according to the present invention. The computing device 1000 is an example of a hardware device to which the above aspects of the present invention can be applied. The computing device 1000 may be any machine configured to perform processing and/or computing. The computing device 1000 may be, but not limited to, a workstation, a server, a desktop computer, a laptop computer, a tablet computer, a personal data assistant (PDA), a smart phone, an in-vehicle computer, or a combination thereof.

As shown in FIG. 10, the computing device 1000 may include one or a plurality of elements that may be connected to or in communication with a bus 1002 via one or a plurality of interfaces. The bus 1002 may include, but not limited to, an Industry Standard Architecture (ISA) bus, a Micro Channel Architecture (MCA) bus, an enhanced ISA (EISA) bus, a Video Electronics Standards Association (VESA) local bus, and a Peripheral Component Interconnect (PCI) bus, etc. The computing device 1000 may include, for example, one or a plurality of processors 1004, one or a plurality of input devices 1006, and one or a plurality of output devices 1008. The one or plurality of processors 1004 may be any kind of processor, and may include, but not limited to, one or a plurality of general-purpose processors or special-purpose processors (such as special-purpose processing chips). The input device 1006 may be any type of input device capable of inputting information to the computing device, and may include, but not limited to, a mouse, a keyboard, a touch screen, a microphone, and/or a remote controller. The output device 1008 may be any type of device capable of presenting information, and may include, but not limited to, a display, a speaker, a video/audio output terminal, a vibrator, and/or a printer.

The computing device 1000 may also include or be connected to a non-transitory storage device 1014. The non-transitory storage device 1014 may be any non-transitory storage device that can implement data storage, and may include, but not limited to, a disk drive, an optical storage device, a solid-state memory, a floppy disk, a flexible disk, a hard disk, a magnetic tape or any other magnetic medium, a compact disk or any other optical medium, a cache memory and/or any other storage chip or module, and/or any other medium from which a computer can read data, instructions and/or code. The computing device 1000 may also include a random access memory (RAM) 1010 and a read-only memory (ROM) 1012. The ROM 1012 may store to-be-executed programs, utilities, or processes in a non-volatile manner. The RAM 1010 may provide volatile data storage and store instructions related to the operation of the computing device 1000. The computing device 1000 may also include a network/bus interface 1016 coupled to a data link 1018. The network/bus interface 1016 may be any kind of device or system capable of enabling communication with an external apparatus and/or network, and may include, but not limited to, a modem, a network card, an infrared communication device, a wireless communication device, and/or a chipset (such a Bluetooth™ device, an 802.11 device, a WiFi device, a WiMax device, and a cellular communication facility).

Various aspects, implementations, specific implementations or features of the foregoing implementations can be used individually or in any combination. The various aspects of the foregoing implementations may be implemented by software, hardware, or a combination of hardware and software.

For example, the foregoing implementations may be embodied as computer-readable code on a computer-readable medium. The computer-readable medium is any data storage device that can store data, and the data can thereafter be read by a computer system. For example, the computer-readable medium includes a read-only memory, a random access memory, a CD-ROM, a DVD, a magnetic tape, a hard disk drive, a solid-state drive, and an optical data storage device. The computer-readable medium can also be distributed to network-coupled computer systems so that the computer-readable code is stored and executed in a distributed manner.

For example, the foregoing implementation may adopt the form of a hardware circuit. The hardware circuit may include any combination of a combined logic circuit, a clock storage device (such as a floppy disk, a flip-flop, and a latch), a finite state machine, a memory such as a static random access memory or an embedded dynamic random access memory, a custom-designed circuit, a programmable logic array, etc.

Some examples of the present invention are shown below.

Example 1. A method for determining a damage level of a textile includes:
receiving an image of at least a part of the textile;
receiving information about a fabric type of the at least a part of the textile;
analyzing the image by using a machine learning method so as to identify a fabric attribute of the at least a part of the textile;
determining a severity value associated with the identified fabric attribute by using the machine learning method according to the received image, the identified fabric attribute and the fabric type; and
determining the damage level of the textile based on the determined severity value.

Example 2. In the method of Example 1, the severity value of the textile is determined by using a severity prediction model; the severity prediction model includes a plurality of convolutional neural network models; each convolutional neural network model is configured to analyze an image of a textile formed by at least one fabric attribute in a plurality of fabric attributes and at least one fabric type in a plurality of fabric types.

Example 3. In the method of Example 1 or Example 2, each convolutional neural network model is trained by using images of a plurality of textiles formed by at least one fabric attribute in the plurality of fabric attributes and at least one fabric type in the plurality of fabric types and having different severity values.

Example 4. In the method of any one of Examples 1 to 3, the images of the plurality of textiles having different severity values are obtained by acquiring corresponding images of the plurality of textiles after machine-washing the plurality of textiles different numbers of times.

Example 5. The method of any one of Examples 1 to 4 further includes:
determining a risk type and level of the textile according to the fabric attribute and the information about the fabric type.

Example 6. The method of any one of Examples 1 to 5 further includes:
determining an estimated age of use of the textile according to the fabric attribute, the fabric type and the damage level.

Example 7. The method of Example 5 further includes:
providing a recommended care policy according to the damage level of the textile and the risk type and level.

Example 8. The method of Example 7 further includes:
providing a recommended care product according to the recommended care policy.

Example 9. In the method of Example 8, providing the recommended care policy or recommended care product is further based on a user input related to a personal preference.

Example 10. The method of Example 8 further includes:
generating simulated care results of caring the textile by using a plurality of care policies and care products.

Example 11. In the method of Example 10, the plurality of care policies and care products include one or more of a default care policy and care product, a user-selected care policy and care product, and the recommended care policy and recommended care product.

Example 12. In the method of any one of Examples 1 to 11, the image of the textile is a macro image, and the macro image is captured by a portable device with a built-in macro lens or an external macro lens connected to the portable device.

Example 13. The method of Example 8 further includes:
providing an option for a user to purchase the care product.

Example 14. In the method of any one of Examples 1 to 13, the fabric attribute is one in the group consisting of: weave type, gloss, elasticity, and a combination thereof.

Example 15. In the method of Example 14, the weave type includes one or more of twill weave, plain weave, knitted, and satin weave.

Example 16. In the method of any one of Examples 1 to 13, the fabric type includes one or more of cotton, TENCEL™, recycled fiber, polyester fiber, lyocell, nylon, high content polyester, low content polyester, modal, wool, cashmere, rayon, acrylic fiber, viscose fiber, artificial cotton, and silk fabric.

Example 17. In the method of Example 16, the silk fabric includes one or more of natural silk fabric, rayon fabric, and silk.

Example 18. In the method of Example 5, the risk type includes one or more of fluffing, pilling, deformation, discoloration, wrinkles, shrinkage, odor, and static electricity.

Example 19. A method for determining a textile condition includes:
receiving a digital image of at least a part of the textile;
electronically analyzing the received digital image by using a machine learning method so as to identify a fabric attribute of the at least a part of the textile, where the fabric attribute is able to indicate the textile condition of the textile; and
determining the textile condition of the textile in the analyzed digital image based on the identified fabric attribute.

Example 20. The method of Example 19 further includes:
assigning a severity degree to the textile condition of the textile in the analyzed digital image.

Example 21. In the method of Example 20, the step of assigning the severity degree includes:
comparing the textile condition with a predetermined value associated with a group of images of the fabric attribute.

Example 22. In the method of Example 21, the severity degree of the textile condition includes a fabric damage value.

Example 23. In the method of any one of Examples 19 to 22, the fabric attribute is one in the group consisting of: weave pattern, fabric type, gloss, elasticity, and a combination thereof.

Example 24. A method for providing a textile care recommendation includes:
receiving an image of at least a part of the textile;
analyzing the image by using a machine learning method so as to identify a fabric attribute of the at least a part of the textile, where the fabric attribute is able to indicate a textile condition of the textile;
determining the textile condition of the textile in the analyzed digital image based on the fabric attribute; and
recommending a textile care policy for caring the textile condition.

Example 25. The method of Example 24 further includes:
assigning a severity degree to the textile condition of the textile in the analyzed digital image.

Example 26. In the method of Example 25, the step of assigning the severity degree includes:
comparing the textile condition with a predetermined value associated with a group of images of the fabric attribute.

Example 27. In the method of Example 26, the severity degree of the textile condition includes a fabric damage value.

Example 28. In the method of any one of Examples 24 to 27, the fabric attribute is one in the group consisting of: weave pattern, fabric type, gloss, elasticity, and a combination thereof.

Example 29. A method for visualizing textile information includes:
displaying a first option so as to receive from a user an image of at least a part of the textile;
displaying a second option so as to receive from the user information about a fabric type of the at least a part of the textile;
analyzing the image by using a machine learning method so as to identify a fabric attribute of the at least a part of the textile;
determining a damage level of the textile by using the machine learning method according to the received image, the fabric attribute and the fabric type; and
displaying the damage level of the textile.

Example 30. The method of Example 29 further includes:
determining and displaying a risk type and level of the textile according to the fabric attribute and the information about the fabric type.

Example 31. The method of Example 29 further includes:
determining and displaying an estimated age of use of the textile according to the fabric attribute, the fabric type, and the damage level.

Example 32. The method of Example 30 or 31 further includes:
displaying a recommended care policy according to the damage level of the textile and the risk type and level.

Example 33. The method of any one of Examples 29 to 32 further includes:
displaying a recommended care product according to the recommended care policy.

Example 34. The method of Example 33 further includes:
displaying a third option so as to receive a user input related to a personal preference, where displaying the recommended care policy or recommended care product is further based on the personal preference.

Example 35. The method of Example 33 or 34 further includes:
displaying simulated care results of caring the textile by using a plurality of care policies and care products.

Example 36. In the method of any one of Examples 33 to 35, the plurality of care policies and care products include one or more of a default care policy and care product, a user-selected care policy and care product, and the recommended care policy and recommended care product.

Example 37. The method of any one of Examples 33 to 36 further includes:
displaying a fourth option so as to enable the user to purchase the care product.

Example 38. In the method of any one of Examples 29 to 37, the fabric attribute is one in the group consisting of: weave type, gloss, elasticity, and a combination thereof.

Example 39. In the method of Example 38, the weave type includes one or more of twill weave, plain weave, knitted, and satin weave.

Example 40. In the method of any one of Examples 29 to 39, displaying the second option includes displaying cotton, TENCEL™, recycled fiber, polyester fiber, lyocell, nylon, high content polyester, low content polyester, modal, wool, cashmere, rayon, acrylic fiber, viscose fiber, artificial cotton, and silk fabric for the user to select.

Example 41. In the method of Example 40, the silk fabric includes one or more of natural silk fabric, rayon fabric, and silk.

Example 42. In the method of any one of Examples 29 to 41, the risk type includes one or more of fluffing, pilling, deformation, discoloration, wrinkles, shrinkage, odor, and static electricity.

Example 43. In the method of any one of Examples 29 to 42, displaying the damage level of the textile includes displaying the damage level of the textile in a statistical graphic, text, percentage, word cloud graphic superimposed on the image of the at least a part of the textile, or any combination thereof.

Example 44. An electronic device includes:
one or a plurality of processors; and
a memory storing computer-executable instructions thereon, where when executed by the one or plurality of processors, the computer-executable instructions cause the one or plurality of processors to perform the method of any one of Examples 1 to 43.

Example 45. A non-transitory computer-readable medium stores computer-executable instructions thereon, where when executed by one or a plurality of processors, the computer-executable instructions cause the one or plurality of processors to perform the method of any one of Examples 1 to 43.

Although some specific embodiments of the present invention have been shown in detail through examples, those skilled in the art should understand that the above examples are intended to be illustrative only and not to limit the scope of the present invention. It should be recognized that some steps in the aforementioned method are not necessarily performed in the order shown, but that they may be performed simultaneously, in a different order, or in an overlapping manner. In addition, those skilled in the art may add some steps or omit some steps as needed. Some components in the foregoing system do not have to be arranged as shown in the figure, and those skilled in the art may add some components or omit some components as needed. Those skilled in the art should understand that the aforementioned embodiments can be modified without departing from the scope and essence of the present invention. The scope of the present invention is defined by the appended claims.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A method for determining a damage level of a textile, comprising:
receiving an image of at least a part of the textile;
receiving information about a fabric type of the at least a part of the textile;
analyzing the image by using a machine learning method so as to identify a fabric attribute of the at least a part of the textile;
determining a severity value associated with the identified fabric attribute by using the machine learning method according to the received image, the identified fabric attribute and the fabric type; and
determining the damage level of the textile based on the determined severity value.

2. The method according to claim 1, wherein the severity value of the textile is determined by using a severity prediction model; the severity prediction model comprises a plurality of convolutional neural network models; each convolutional neural network model is configured to analyze an image of a textile formed by at least one fabric attribute in a plurality of fabric attributes and at least one fabric type in a plurality of fabric types.

3. The method according to claim 2, wherein each convolutional neural network model is trained by using images of a plurality of textiles formed by at least one fabric attribute in the plurality of fabric attributes and at least one fabric type in the plurality of fabric types and having different severity values.

4. The method according to claim 3, wherein the images of the plurality of textiles having different severity values are obtained by acquiring corresponding images of the plurality of textiles after machine-washing the plurality of textiles different numbers of times.

5. The method according to claim 1, further comprising: determining a risk type and level of the textile according to the fabric attribute and the information about the fabric type, preferably the risk type comprises one or more of fluffing, pilling, deformation, discoloration, wrinkles, shrinkage, odor, and static electricity.

6. The method according to claim 1, further comprising:
determining an estimated age of use of the textile according to the fabric attribute, the fabric type and the damage level.

7. The method according to claim 5, further comprising:
providing a recommended care policy according to the damage level of the textile and the risk type and level.

8. The method according to claim 7, further comprising:
providing a recommended care product according to the recommended care policy.

9. The method according to claim 8, wherein providing the recommended care policy or recommended care product is further based on a user input related to a personal preference.

10. The method according to claim 8, further comprising:
generating simulated care results of caring the textile by using a plurality of care policies and care products.

11. The method according to claim 10, wherein the plurality of care policies and care products comprise one or more of a default care policy and care product, a user-selected care policy and care product, and the recommended care policy and recommended care product.

12. The method according to claim 1, wherein the image of the textile is a macro image, and the macro image is captured by a portable device with a built-in macro lens or an external macro lens connected to the portable device.

13. The method according to claim 8, further comprising:
providing an option for a user to purchase the care product.

14. The method according to claim 1, wherein the fabric attribute is one in the group consisting of: weave type, gloss, elasticity, and a combination thereof, preferably the weave type comprises one or more of twill weave, plain weave, knitted, and satin weave.

15. The method according to claim 1, wherein the fabric type comprises one or more of cotton, TENCEL™, recycled fiber, polyester fiber, lyocell, nylon, high content polyester, low content polyester, modal, wool, cashmere, rayon, acrylic fiber, viscose fiber, artificial cotton, and silk fabric, preferably, the silk fabric comprises one or more of natural silk fabric, rayon fabric, and silk.

16. A method for providing a textile care recommendation, comprising:
receiving an image of at least a part of the textile;
analyzing the image by using a machine learning method so as to identify a fabric attribute of the at least a part of the textile, wherein the fabric attribute is able to indicate a textile condition of the textile;
determining the textile condition of the textile in the analyzed digital image based on the fabric attribute; and
recommending a textile care policy for caring the textile condition.

17. A method for visualizing textile information, comprising:
displaying a first option so as to receive from a user an image of at least a part of the textile;
displaying a second option so as to receive from the user information about a fabric type of the at least a part of the textile;
analyzing the image by using a machine learning method so as to identify a fabric attribute of the at least a part of the textile;
determining a damage level of the textile by using the machine learning method according to the received image, the fabric attribute and the fabric type; and
displaying the damage level of the textile.

18. The method according to claim 17, further comprising:
determining and displaying a risk type and level of the textile according to the fabric attribute and the information about the fabric type.

19. An electronic device, comprising:
one or a plurality of processors; and
a memory storing computer-executable instructions thereon, wherein when executed by the one or plurality of processors, the computer-executable instructions cause the one or plurality of processors to perform the method according to claim 1.

20. A non-transitory computer-readable medium storing computer-executable instruction thereon, wherein when executed by one or a plurality of processors, the computer-executable instructions cause the one or plurality of processors to perform the method according to claim 1.
